(19) United States
(12) Patent Application Publication
(10) Pub. No.: US 2026/0006096 A1
(43) Pub. Date: Jan. 1, 2026

(54) DEVICES AND METHODS FOR DUPLICATE DELIVERY PREVENTION FOR DYNAMICALLY CONNECTED TRANSPORT PROTOCOLS

(71) Applicant: MELLANOX TECHNOLOGIES, LTD., Yokneam (IL)

(72) Inventors: Yamin FRIEDMAN, Jerusalem (IL); Idan BURSTEIN, Carmiel (IL); Ariel SHAHAR, Jerusalem (IL); Diego CRUPNICOFF, Buenos Aires (AR); Roee MOYAL, Yoqneam Ilit (IL); Miriam MENES, Tel Aviv (IL)

(73) Assignee: MELLANOX TECHNOLOGIES, LTD., Yokneam (IL)

(21) Appl. No.: 18/756,506

(22) Filed: Jun. 27, 2024

(51) Int. Cl. H04L 67/141

(52) U.S. Cl. CPC H04L 67/141

(57) ABSTRACT

Devices, methods, and computer program products are provided for duplicate delivery prevention for dynamically connected transport protocols. An example method includes receiving, by a destination device, a first data packet from a transmitting device that includes instructions for establishing a dynamic connection between the destination device and the transmitting device and establishing the dynamic connection between the destination device and the transmitting device based on the first data packet. The method further includes maintaining the dynamic connection between the destination device and the transmitting device for at least a threshold time period (T) defining a duration during which data packets are received by the destination device from the transmitting device. Each of the data packets received by the destination device from the transmitting device via the dynamic connection during the threshold time period (T) include data entries indicative of a time at which the respective data packet was transmitted.

### TECHNOLOGICAL FIELD

Embodiments of the present disclosure relate generally to data communication systems, and, more particularly, to data transport protocols used in dynamically connected communication systems.

### BACKGROUND

Datacenters, high performance computing clusters, communication networks, and/or the like are often formed of various computing components (e.g., hosts, nodes, servers, racks, switches, etc.). For example, a communication network may be formed of a plurality of nodes, the connections of which may be governed by various data transport protocols. Through applied effort, ingenuity, and innovation, many of the problems associated with conventional networking and computing systems have been solved by developing solutions that are included in embodiments of the present disclosure, many examples of which are described in detail herein.

### BRIEF SUMMARY

Embodiments of the present disclosure provide for devices, methods, systems, and computer program products for duplicate delivery prevention for dynamically connected transport protocols. With reference to an example computer-implemented method, the method may include receiving, by a destination device, a first data packet from a transmitting device, wherein the first data packet includes one or more instructions for establishing a dynamic connection (DC) between the destination device and the transmitting device. The method may further include establishing the dynamic connection between the destination device and the transmitting device based on the first data packet. The method may further include maintaining the dynamic connection between the destination device and the transmitting device for at least a threshold time period (T) defining a duration during which data packets are received by the destination device from the transmitting device. Each of the data packets received by the destination device from the transmitting device via the dynamic connection during the threshold time period (T) may include one or more data entries indicative of a time at which the respective data packet was transmitted by the transmitting device.

In some embodiments, the method may further include discarding data packets that are received outside the threshold time period (T).

In some embodiments, the method may further include terminating the dynamic connection in response to a termination data packet received by the destination device from the transmitting device that includes one or more instructions for terminating the dynamic connection.

In some embodiments, the destination device and the transmitting device may be formed in a network having a common global time field.

In some further embodiments, the threshold time period (T) may be received by the destination device from a global time field source associated with the network.

Additionally or alternatively, in some embodiments, the threshold time period (T) may be determined at least in part based upon an average Round Trip Time (RTT) for the network.

In some embodiments, the one or more data entries of the first data packet may include the threshold time period (T).

In some embodiments, the method may further include receiving a second data packet including one or more data entries indicative of a time at which the second data packet was transmitted by the transmitting device. In such an embodiment, the method may include storing the second data packet in an instance in which the time at which the second data packet was transmitted is in within the threshold time period (T) and discarding the second data packet in an instance in which the time at which the second data packet was transmitted is outside the threshold time period (T).

A computing device for duplicate delivery prevention for dynamically connected transport protocols is also provided that includes a non-transitory storage device and a processor coupled to the non-transitory storage device. The processor may be configured to receive a first data packet from a transmitting device where the first data packet includes one or more instructions for establishing a dynamic connection (DC) between the computing device and the transmitting device and establish the dynamic connection between the computing device and the transmitting device based on the first data packet. The processor may be further configured to maintain the dynamic connection between the computing device and the transmitting device for at least a threshold time period (T) defining a duration during which data packets are received by the computing device from the transmitting device. Each of the data packets received by the computing device from the transmitting device via the dynamic connection during the threshold time period may include one or more data entries indicative of a time at which the respective data packet was transmitted by the transmitting device.

A computer program product for duplicate delivery prevention for dynamically connected transport protocols is also provided. The computer program product may include at least one non-transitory computer-readable storage medium having computer program code thereon that, in execution with at least one processor, configures the computer program product for receiving, by a destination device, a first data packet from a transmitting device where the first data packet includes one or more instructions for establishing a dynamic connection (DC) between the destination device and the transmitting device and establishing the dynamic connection between the destination device and the transmitting device based on the first data packet. The computer program product may be further configured for maintaining the dynamic connection between the destination device and the transmitting device for at least a threshold time period (T) defining a duration during which data packets are received by the destination device from the transmitting device. Each of the data packets received by the destination device from the transmitting device via the dynamic connection during the threshold time period may include one or more data entries indicative of a time at which the respective data packet was transmitted by the transmitting device.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described certain example embodiments of the present disclosure in general terms, reference will now be made to the accompanying drawings. The components illustrated in the figures may or may not be present in certain embodiments described herein. Some embodiments may include fewer (or more) components than those shown in the figures.

FIG. 1 illustrates an example of duplicate data delivery in dynamically connected (DC) transports addressed by one or more embodiments of the present disclosure;

FIG. 2 illustrates an example communication network for implementing one or more embodiments of the present disclosure;

FIG. 3 illustrates a block diagram of example destination device circuitry that may be specifically configured in accordance with an example embodiment of the present disclosure;

FIG. 4 illustrates a flowchart of an example method for duplicate delivery prevention, in accordance with some embodiments of the present disclosure; and

FIG. 5 illustrates a flowchart of an example method for data packet storage determinations in accordance with some embodiments of the present disclosure.

### DETAILED DESCRIPTION

### Overview

Various embodiments of the present disclosure will now be described more fully hereinafter with reference to the accompanying drawings in which some but not all embodiments are shown. Indeed, the present disclosure may be embodied in many different forms and should not be construed as limited to the embodiments set forth herein; rather these embodiments are provided so that this disclosure will satisfy applicable legal requirements. Like reference numerals refer to like elements throughout.

As used herein, the terms “data,” “content,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein as receiving data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein as sending data to another computing device, it will be appreciated that the data may be sent directly to another computing device or may be sent indirectly via one or more intermediary computing devices, such as, for example, one or more servers, relays, routers, network access points, base stations, hosts, and/or the like.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

The terms “illustrative,” “exemplary,” and “example” as may be used herein are not provided to convey any qualitative assessment, but instead merely to convey an illustration of an example. Thus, use of any such terms should not be taken to limit the spirit and scope of embodiments of the present disclosure. The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment).

As described above, datacenters, high performance computing clusters, communication networks, and/or the like are often formed of various computing components (e.g., hosts, nodes, servers, racks, switches, etc.). For example, a communication network may be formed of a plurality of nodes, the connections of which may be governed by various data transport protocols. For example, data transport protocols may be used to provide delivery guarantees and, in traditional systems, a connection state on both sides of the network (e.g., between transmitting and destination devices) may be used for this guarantee. Such a connection state, however, requires allocated memory, and the connection establishment is completed outside of the data path to ensure that the connection is established reliably before data is sent. When attempting to scale device communication, such as in a scaling network of thousands of nodes each having hundreds of processes, the state required for connected transports often becomes prohibitively expensive.

As such, dynamically connected (DC) data transport protocols may be leveraged. As would be evident to one of ordinary skill in the art, a DC data transport protocol may refer to a data transport that does not maintain any connection state while traffic (e.g., data packets) is not being sent. In a DC transport, a connection is established (e.g., between a destination and a transmitting device) in-line with the first data packet that is transmitted (e.g., by the transmitting device) and then removed by sending a data packet (e.g., by the transmitting device) indicating that all the data was successfully transmitted and received. Because the destination or receiving device in a DC transport protocol does not maintain a permanent state, the destination device is incapable of differentiating between the two versions of the same data packet or message. As such, a destination device may receive duplicate delivery of data packets.

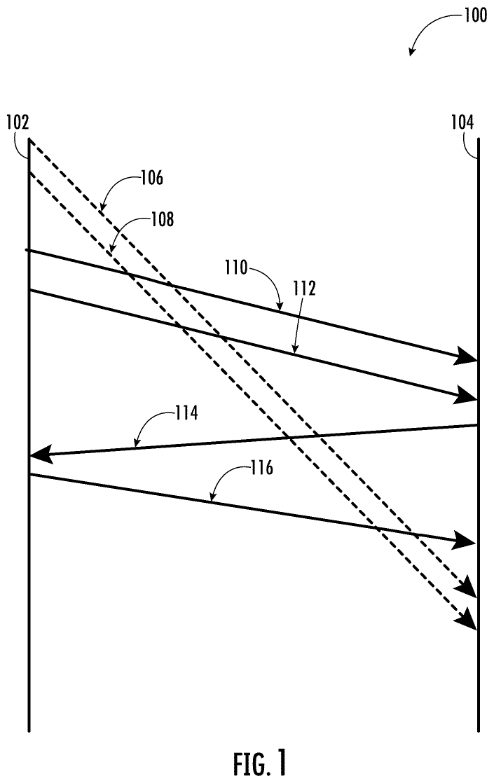

As shown in FIG. 1, an example of duplicate data delivery in dynamically connected (DC) transports 100 is illustrated. As shown, a transmitting device 102 may attempt to establish communication with a destination device 104 such that data packets may be transmitted therebetween. The transmitting device 102 may leverage a DC transport by transmitting a request for the DC connection 106 (e.g., DC Connect ISID 0) alongside a data packet via remote direct memory access (RDMA) transmission 108 (e.g., RDMA ISID 0) at a first transmission time. The transmitting device 102 may similarly transmit a request for the DC connection 110 (e.g., DC Connect ISID 0) alongside a data packet via RDMA transmission 112 (e.g., RDMA ISID 0) at a second transmission time that is later in time than the first transmission time. Although transmitted at a second transmission time that is later in time than the first transmission time, the destination device 104 may, for example, receive the data packets 110, 112 before receiving the data packets 106, 108. As such, the destination device 104 may transmit data packets in response at transmission 114, and the transmitting device 102 may transmit a data packet 116 to terminate the DC connection 116 (e.g., DC disconnect ISID 0). The data packet 116 ending the connection, however, may be received prior to receipt of the data packets 106, 108 by the destination device 104. In other words, the initial packets of a new connection may be duplicated or delayed such that they arrive at the destination device 104 at a point in time in which the dynamic connections created do not overlap. Because the destination device 104 does not maintain a permanent state, the destination device 104 is incapable of differentiating between the two versions of the same message and thus will deliver both. In doing so, the connection illustrated in FIG. 1 may break the reliability guarantee to prevent duplicate delivery.

In order to solve these problems and others, the embodiments of the present disclosure provide a method for preventing duplicate delivery in DC transport protocols by timestamping data packets within a globally accepted time field. For example, a dynamic connection between a transmitting device and destination device may be established that includes a threshold time period (T) during which timestamped data packets may be received by the destination device. If a data packet is received that has a time stamp (e.g., indicative of the time at which the data packet was transmitted) that is outside of the threshold time period, the destination device may discard this data packet. The threshold time period may be received from a global time field source and/or be based at least in part on the Round Trip Time (RTT) and/or error bound for time synchronization of the network including the transmitting and destination devices. In doing so, the embodiments of the present disclosure may operate to gain the network scaling benefits of DC transport protocols while preventing the delivery of duplicate data packets as often found in conventional implementations.

### Example Communication Network

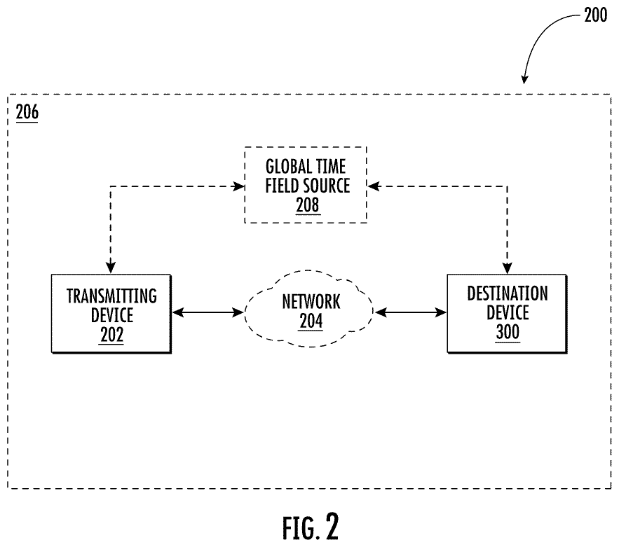

FIG. 2 illustrates an example communication network 200 (e.g., network 200) as an example system for preventing duplicate data delivery in dynamically connected (DC) transports. It will be appreciated that the network 200 is provided as an example of an embodiment(s) and should not be construed to narrow the scope or spirit of the disclosure. The depicted network 200 of FIG. 2 may include a destination device 300 (e.g., a receiving device, a responder device, etc.) capable of communicating with other devices in the network 200 via a DC data transport protocol as described herein. The destination device 300 may be communicatively connected to one or more transmitting devices 202 by a communication network 204. Although illustrated in FIG. 2 as a single destination device 300 in the network 200, the present disclosure contemplates that the network 200 may include any number of destination devices 300. Similarly, although illustrated in FIG. 2 as a single transmitting device 202 in the network 200, the present disclosure contemplates that the network 200 may include any number of transmitting devices 202. Furthermore, the present disclosure contemplates that any device, node, etc. within the network 200 may operate as a destination device 300 or transmitting device 202. For example, the destination device 300 may, in some instances, perform the operations described herein with reference to the transmitting device 202, and/or the transmitting device 202 may, in some instances, perform the operations described herein with reference to the destination device 300.

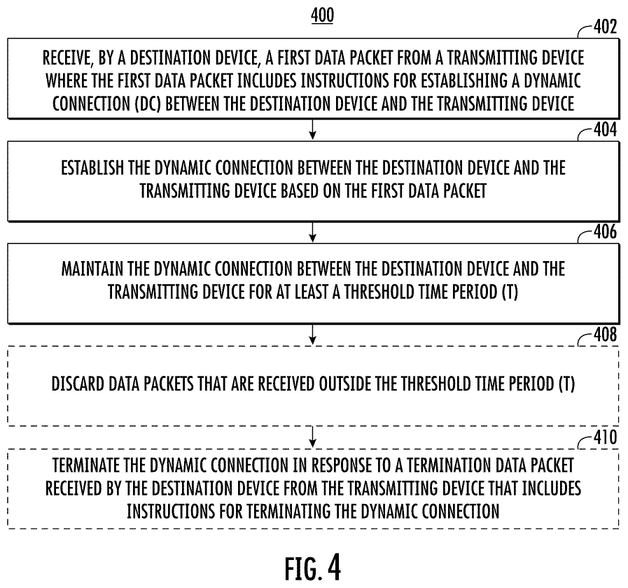

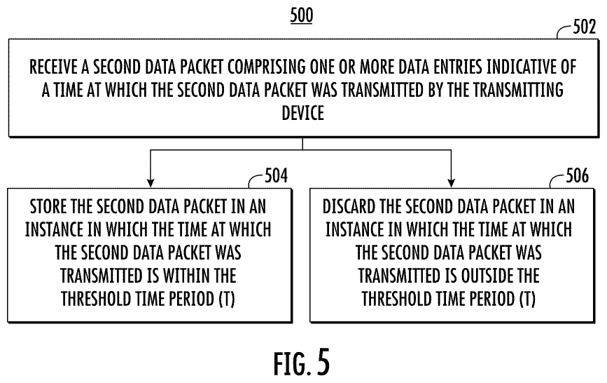

Although described hereinafter with reference to a destination device 300, the present disclosure contemplates that the operations described hereafter with reference to FIGS. 4-5 may be performed by any computing device, system orchestrator, central processing unit (CPU), graphics processing unit (GPU), data processing unit (DPU), and/or the like that may operate as a node in the network 200. Furthermore, although illustrated as a single device (e.g., destination device 300), the present disclosure contemplates that any number of distributed components may collectively be used to perform the operations described herein. The destination device 300 may be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware.

The network 200 may further include a transmitting device 202 as described above. The transmitting device may similarly include any computing device, system orchestrator, central processing unit (CPU), graphics processing unit (GPU), data processing unit (DPU), and/or the like that may operate as a node in the network 200. Furthermore, although illustrated as a single device (e.g., transmitting device 202), the present disclosure contemplates that any number of distributed components may collectively be used to perform the operations described herein. The transmitting device 202 may also be embodied in an entirely hardware embodiment, an entirely computer program product embodiment, an entirely firmware embodiment (e.g., application-specific integrated circuit, field-programmable gate array, etc.), and/or an embodiment that comprises a combination of computer program products, hardware, and firmware.

The communication network 204 may be any means including hardware, software, devices, or circuitry that is configured to support the transmission of computer messages between system nodes. For example, the communication network 204 may be formed of components supporting wired transmission protocols, such as, digital subscriber line (DSL), Ethernet, fiber distributed data interface (FDDI), or any other wired transmission protocol obvious to a person of ordinary skill in the art. The communication network 204 may also be comprised of components supporting wireless transmission protocols, such as Bluetooth, IEEE 802.11 (Wi-Fi), or other wireless protocols obvious to a person of ordinary skill in the art. In addition, the communication network 204 may be formed of components supporting a standard communication bus, such as, a Peripheral Component Interconnect (PCI), PCI Express (PCIe or PCI-e), PCI extended (PCI-X), Accelerated Graphics Port (AGP), or other similar high-speed communication connection. Further, the communication network 204 may be comprised of any combination of the above mentioned protocols. As described herein, the devices 202, 300 may communicate via a dynamically connected (DC) data transport protocol. As such, the present disclosure contemplates that the communication network 204 described herein may be configured to enable DC data transport protocols.

With continued reference to FIG. 2, the network 200 may include a common global time field 206 within which the transmitting device 202 and the destination device 300 may be provided. As would be evident to one of ordinary skill in the art in light of the present disclosure, each of the devices 202, 300 within the network 200 may, for example, include various mechanisms for determining or otherwise accounting for time. These devices 202, 300 may also leverage various time synchronization operations in order to account for time discrepancies, deviations, etc. By way of a non-limiting example, the transmitting device 202 and the destination device 300 may each include local clocks that operate to maintain a respective time value for each of the transmitting device 202 and the destination device 300. The local clocks for the transmitting device 202 and the destination device 300 may be periodically synchronized with the time value for the global time field 206. In other words, the common global time field 206 may refer to any structure, mechanism, technique, etc. for establishing a time that is globally accepted by the devices in the network 200 (e.g., at least the destination device 300 and the transmitting device 202).

By way of a non-limiting example, the global time field 206 may be associated with a global time field source 208 (e.g., a master clock, a global clock, etc.) by which the example local clocks of the transmitting device 202 and the destination device 300 may be synchronized. The devices 202, 300 in the global time field 206 of the network 200 may further include various characteristics, attributes, parameters, metrics, etc. that are associated with the operation of these devices 202, 300. By way of a non-limiting example, the devices 202, 300 in the global time field 206 of the network 200 may be associated with an average Round Trip Time (RTT) (e.g., time required to receive a response after a request in the network 200 is initiated). As described hereinafter, the various characteristics, attributes, parameters, metrics, etc. of the devices 202, 300 in the global time field 206 of the network 200 may be used, at least in part, to determine a threshold time period (T). As such, the present disclosure contemplates that any characteristics, attribute, parameter, metric, etc. of the devices 202, 300 in the global time field 206 of the network 200 may be used to determine this threshold time period (T). Furthermore, the present disclosure contemplates that the techniques described herein may account for any delay between devices (e.g., transmitting device 202 and destination device 300) and the error bound, if any, associated with synchronization.

### Example Destination Device Circuitry

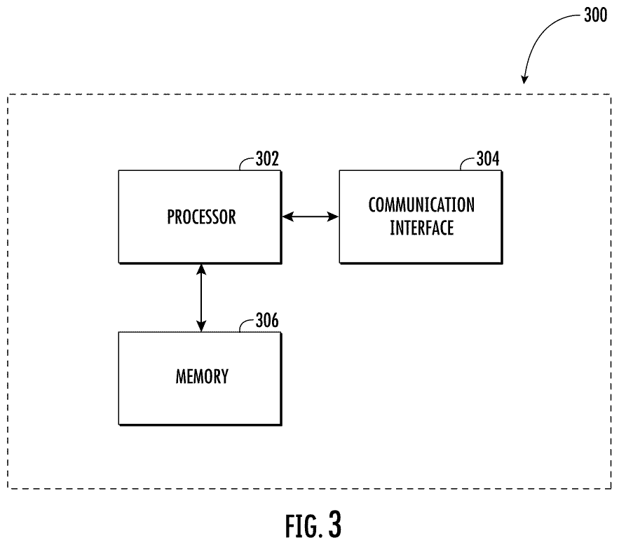

With reference to FIG. 3, example circuitry components of the destination device 300 are illustrated that may, alone or in combination with any of the components described herein, be configured to perform the operations described herein with reference to FIGS. 4-5. As shown, the destination device 300 may include, be associated with or be in communication with processor 302, a memory 306, and a communication interface 304. The processor 302 may be in communication with the memory 306 via a bus for passing information among components of the destination device 300. The memory 306 may be non-transitory and may include, for example, one or more volatile and/or non-volatile memories. In other words, for example, the memory 306 may be an electronic storage device (e.g., a computer readable storage medium) comprising gates configured to store data (e.g., bits) that may be retrievable by a machine (e.g., a computing device like the processing circuitry). The memory 306 may be configured to store information, data, content, applications, instructions, or the like for enabling the apparatus to carry out various functions in accordance with an example embodiment of the present disclosure. For example, the memory 306 could be configured to buffer input data for processing by the processor 302. Additionally or alternatively, the memory 306 could be configured to store instructions for execution by the processor 302.

The destination device 300 (e.g., example apparatus of the present disclosure) may, in some embodiments, be embodied in various computing devices as described above. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present disclosure on a single chip or as a single “system on a chip.” As such, in some cases, a chip or chipset may constitute means for performing one or more operations for providing the functionalities described herein.

The processor 302 may be embodied in a number of different ways. For example, the processor 302 may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining and/or multithreading.

In an example embodiment, the processor 302 may be configured to execute instructions stored in the memory 306 or otherwise accessible to the processor 302. Alternatively or additionally, the processing circuitry may be configured to execute hard coded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processor 302 is embodied as an executor of instructions, the instructions may specifically configure the processor to perform the algorithms and/or operations described herein when the instructions are executed. However, in some cases, the processor 302 may be a processor of a specific device configured to employ an embodiment of the present disclosure by further configuration of the processing circuitry by instructions for performing the algorithms and/or operations described herein. The processor 302 may include, among other things, a clock, an arithmetic logic unit (ALU) and logic gates configured to support operation of the processing circuitry.

The communication interface 304 may be any means such as a device or circuitry embodied in either hardware or a combination of hardware and software that is configured to receive and/or transmit data, including media content in the form of video or image files, one or more audio tracks or the like. In this regard, the communication interface 304 may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms. As described above, the destination device 300 may be configured to communication with the transmitting device 202 via a DC data transport protocol. As such, the communication interface 304 of the destination device 300 may include any circuitry components, hardware, etc. required to establish a connection with the transmitting device via such a DC data transport protocol.

Although described herein with reference to the circuitry components of the destination device 300 in FIG. 3, the present disclosure contemplates that any device within the network 200 may include the circuitry components of FIG. 3. As described above, the destination device 300 may, in some instances, perform the operations described herein with reference to the transmitting device 202, and/or the transmitting device 202 may, in some instances, perform the operations described herein with reference to the destination device 300. As such, the transmitting device 202 may similarly include a processor, memory, communication interface, and/or the like for performing the operations described herein with reference to the destination device.

Of course, while the term “circuitry” should be understood broadly to include hardware, in some embodiments, the term “circuitry” may also include software for configuring the hardware. For example, although “circuitry” may include processing circuitry, storage media, network interfaces, input/output devices, and the like, other elements of the destination device 300 may provide or supplement the functionality of particular circuitry.

### Example Methods for Duplicate Delivery Prevention

FIG. 4 illustrates a flowchart containing a series of operations for duplicate delivery prevention (e.g., method 400). The operations illustrated in FIG. 4 may, for example, be performed by, with the assistance of, and/or under the control of an apparatus (e.g., destination device 300), as described above. In this regard, performance of the operations may invoke one or more of processor 302, memory 306, and/or communication interface 304.

As shown in operation 402, the apparatus (e.g., destination device 300) includes means, such as communication interface 304, or the like, for receiving a first data packet from a transmitting device 202. The first data packet received at operation 402 may include one or more instructions for establishing a dynamic connection (DC) between the destination device 300 and the transmitting device 202. By way of a non-limiting example, the first data packet may include data entries that identify the transmitting device 202 to the destination device 300 and data entries that are associated with a request for establishing a dynamic connection (DC) with the transmitting device (e.g., a communication link between the destination device 300 and the transmitting device 202 based on a dynamically connected (DC) data transport protocol). In some embodiments, the first data packet may be transmitted via a remote direct memory access (RDMA) based communication. For example, the transmitted device 202 be configured to, in transmitting data packets, directly access the memory of the destination device 300 without involving the operating system of the destination device 300, and vice versa.

As would be evident to one of ordinary skill in the art, the first data packet may include data entries indicative of or otherwise associated with the data to be transmitted between the transmitting device 202 and the destination device 300. By way of a non-limiting example, the first data packet may include any identifier (e.g., a queue pair (QP) number, a transaction ID, an initiator ID, a responder ID, and/or the like) associated with the transmitting device 202 and/or the destination device 300. Furthermore, the present disclosure contemplates that the information required to determine that the data packets belong to the same connection may include any data for distinguishing between source, such as in instances in which different transmitting devices transmit data packets to the same destination device 300 (e.g., same destination address).

Thereafter, as shown in operation 404, the apparatus (e.g., destination device 300) includes means, such as the processor 302, or the like, for establishing the dynamic connection between the destination device 300 and the transmitting device 202 based on the first data packet. As described above, a DC data transport protocol may refer to a data transport that does not maintain any connection state while traffic (e.g., data packets) is not being sent. In a DC transport, a connection is established (e.g., between a destination and a transmitting device) in-line with the first data packet that is transmitted (e.g., by the transmitting device) and then removed by sending a data packet (e.g., by the transmitting device) indicating that all the data was successfully transmitted and received. As such, the first data packet received by the destination device 300 from the transmitting device 202 at operation 402 may include the data entries (e.g., in number, type, etc.) required for establishing a DC transport protocol based connection. The present disclosure contemplates that, based on the nature of the network 200, the devices 202, 300, and/or the like, the data required to establish a DC transport protocol based connection may vary. At operation 404, the present disclosure therefore contemplates that the first data packet received at operation 402 includes the data entries that, at least in part, are required for establishing the DC transport protocol based connection with at least the transmitting device 202. By way of a non-limiting example, each of the data packets in the first set may include any applicable keys (e.g., encryption related or otherwise) for verifying a particular connection.

Thereafter, as shown in operation 406, the apparatus (e.g., destination device 300) includes means, such as the processor 302, or the like, for maintaining the dynamic connection between the destination device and the transmitting device for at least a threshold time period (T) during which data packets are received by the destination device 300 from the transmitting device 202. As described more fully hereinafter with reference to operations 408 and the operations of FIG. 5, the threshold time period (T) may refer to a time value against which the transmitted time for data packets may be compared. In order to prevent the duplicate delivery of data packets as described above with reference to FIG. 1, the embodiment of the present disclosure may leverage the threshold time period (T) as a metric for determining if a data packet received by the destination device exceeds an acceptable time period during which the data packet may be reasonably associated with the DC transport protocol based connected established based on the first data packet received at operation 402.

In some embodiments, the threshold time period (T) may be received by the destination device 300 from the global time field source 208 as described above with reference to FIG. 2. By way of a continued example, the global time field source 208 may include or otherwise be associated with a master or global clock by which the example local clocks of the transmitting device 202 and the destination device 300 may be synchronized. As such, the global time field source 208 may operate to determine, based on the various time-related data entries received by the global time field source 208, the threshold time period (T). In some embodiments, one or more data entries of the first data packet received at operation 402 may include the threshold time period (T). By way of a non-limiting example, the transmitting device 202 may, in some instances, determine a time period that is associated with the operations of the particular communication transmitted as part of the operations of FIG. 4 (e.g., based on a statistical analysis, average time required, and/or the like). In such an example, the transmitting device 202 may provide this determined threshold time period (T) as part of the data packets used to establish the DC data protocol based communication. In some embodiments, the Round Trip Time (RTT) (e.g., time required to receive a response after a request in the network 200 is initiated), the error bound for time synchronization of the network 200, and/or the like may be used to at least partially determine the threshold time period (T). As described above, the present disclosure contemplates that any characteristics, attribute, parameter, metric, etc. of the devices 202, 300 in the global time field 206 of the network 200 may be used to determine this threshold time period (T).

With continued reference to operation 406, each of the data packets received by the destination device 300 from the transmitting device 202 via the dynamic connection during the threshold time period (T) may include one or more data entries indicative of a time at which the respective data packet was transmitted by the transmitting device 202. By way of continued example, the transmitting device 202 may include a local clock that operates to maintain a respective time value for each of the transmitting device 202. The local clocks for the transmitting device 202 may, in some embodiments, be periodically synchronized with the time value for the global time field 206. As such, when generating the data packets that are transmitted to the destination device 300, the transmitting device 202 may timestamp each data packet with a value indicative of a time at which the respective data packet was transmitted by the transmitting device 202. As described hereinafter with reference to the operations of FIG. 5, the data entries indicative of a time at which the respective data packet was transmitted by the transmitting device may be compared with the threshold time period (T) to determine if the data packet should be stored, saved, or otherwise used by the destination device 300 or otherwise discarded.

In some embodiments, as shown in operation 408, the apparatus (e.g., destination device 300) includes means, such as the processor 302, or the like, for discarding data packets that are received outside the threshold time period (T). As described hereafter with reference to FIG. 5, the destination device 300 may operate to receive a plurality of data packets following receipt of the first data packet at operation 402 that is used to establish the DC data transport based connection between the transmitting device 202 and the destination device 300. As such, the destination device 300 may operate to determine data packets that have a time value (e.g., the time the data packet was transmitted) that exceeds the threshold time period (T) or otherwise fails to comply with the threshold time period (T). In some embodiments, these data packets may be discarded to prevent the duplicate delivery of data packets as described above. In some embodiments, as shown in operation 408, the apparatus (e.g., destination device 300) includes means, such as the processor 302, communication interface 304, or the like, for terminating the dynamic connection in response to a termination data packet received by the destination device 300 from the transmitting device 202 that includes one or more instructions for terminating the dynamic connection. The present disclosure contemplates that the DC data transport based connection between the destination device 300 and the transmitting device 202 may be terminated by any applicable mechanism, technique, or protocol based on the intended application of the device 202, 300, and/or the network 200.

FIG. 5 illustrates a flowchart containing a series of operations for an example method for data packet storage determinations (e.g., method 500). The operations illustrated in FIG. 5 may, for example, be performed by, with the assistance of, and/or under the control of an apparatus (e.g., destination device 300), as described above. In this regard, performance of the operations may invoke one or more of processor 302, memory 306, and/or communication interface 304.

As shown in operation 502, the apparatus (e.g., destination device 300) includes means, such as processor 302, communication interface 304, or the like, for receiving a second data packet including one or more data entries indicative of a time at which the second data packet was transmitted by the transmitting device 202. As described herein, the second data packet may refer to any data packet that is received by the destination device 300 from the transmitting device 202 after receipt of the first data packet as described above with reference to operation 402. Said differently, the destination device 300 may receive a plurality of data packets from the transmitting device 202 (and other devices) and may determine the time value for these data packets that is indicative of the time at which the particular data packet (e.g., the second data packet) was transmitted by the transmitting device 202. The receipt of the second data packet(s) may occur substantially the same as described above with reference to the first data packet received at operation 402.

As shown in operations 504 and 506, the apparatus (e.g., destination device 300) includes means, such as processor 302, communication interface 304, or the like, for storing the second data packet in an instance in which the time at which the second data packet was transmitted is in within the threshold time period (T) and discarding the second data packet in an instance in which the time at which the second data packet was transmitted is outside the threshold time period (T). As described above, the threshold time period (T) may refer to a time value against which the transmitted time for data packets may be compared. In order to prevent the duplicate delivery of data packets as described above with reference to FIG. 1, the embodiment of the present disclosure may leverage the threshold time period (T) as a metric for determining if a data packet received by the destination device 300 exceeds an acceptable time period during which the data packet may be reasonably associated with the DC transport protocol based connected established based on the first data packet received at operation 402. In some instances, as shown at operation 504, the time value for the second data packet may be within, not exceed, and/or otherwise satisfy the threshold time period (T) indicating that the second data packet is associated with the DC transport protocol based connected established based on the first data packet received at operation 402. In other instances, as shown at operation 506, the time value for the second data packet may be outside, exceed, or otherwise fail to satisfy the threshold time period (T) indicating that the second data packet is not sufficiently associated with the DC transport protocol based connected established based on the first data packet received at operation 402. In this way, the embodiments of the present disclosure may operate to prevent the duplicate delivery of data packets in dynamically connected (DC) data transport protocol based connections.

Many modifications and other embodiments of the inventions set forth herein will come to mind to one skilled in the art to which these inventions pertain having the benefit of teachings presented in the foregoing descriptions and the associated drawings. Although the figures only show certain components of the apparatus and systems described herein, it is understood that various other components may be used in conjunction with the system. Therefore, it is to be understood that the inventions are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. The disclosed embodiments relate primarily to a network interface environment, however, one skilled in the art may recognize that such principles may be applied to any scheduler receiving commands and/or transactions and having access to two or more processing cores. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A computer-implemented method comprising:
receiving, by a destination device, a first data packet from a transmitting device, wherein the first data packet comprises one or more instructions for establishing a dynamic connection (DC) between the destination device and the transmitting device;
establishing the dynamic connection between the destination device and the transmitting device based on the first data packet; and
maintaining the dynamic connection between the destination device and the transmitting device for at least a threshold time period (T) defining a duration during which data packets are received by the destination device from the transmitting device, wherein each of the data packets received by the destination device from the transmitting device via the dynamic connection during the threshold time period (T) comprise one or more data entries indicative of a time at which the respective data packet was transmitted by the transmitting device.

2. The computer-implemented method according to claim 1, further comprising discarding data packets that are received outside the threshold time period (T).

3. The computer-implemented method according to claim 1, further comprising terminating the dynamic connection in response to a termination data packet received by the destination device from the transmitting device that comprises one or more instructions for terminating the dynamic connection.

4. The computer-implemented method according to claim 1, wherein the destination device and the transmitting device are formed in a network having a common global time field.

5. The computer implemented method according to claim 4, wherein the threshold time period (T) is received by the destination device from a global time field source associated with the network.

6. The computer-implemented method according to claim 4, wherein the threshold time period (T) is determined at least in part based upon an average Round Trip Time (RTT) for the network.

7. The computer-implemented method according to claim 1, wherein one or more data entries of the first data packet comprise the threshold time period (T).

8. The computer-implemented method according to claim 1, further comprising:
receiving a second data packet comprising one or more data entries indicative of a time at which the second data packet was transmitted by the transmitting device;
storing the second data packet in an instance in which the time at which the second data packet was transmitted is in within the threshold time period (T); and
discarding the second data packet in an instance in which the time at which the second data packet was transmitted is outside the threshold time period (T).

9. A computing device comprising:
a non-transitory storage device; and
a processor coupled to the non-transitory storage device, wherein the processor is configured to:
receive a first data packet from a transmitting device, wherein the first data packet comprises one or more instructions for establishing a dynamic connection (DC) between the computing device and the transmitting device;
establish the dynamic connection between the computing device and the transmitting device based on the first data packet; and
maintain the dynamic connection between the computing device and the transmitting device for at least a threshold time period (T) defining a duration during which data packets are received by the computing device from the transmitting device, wherein each of the data packets received by the computing device from the transmitting device via the dynamic connection during the threshold time period comprise one or more data entries indicative of a time at which the respective data packet was transmitted by the transmitting device.

10. The computing device according to claim 9, wherein the processor is further configured to discard data packets that are outside the threshold time period (T).

11. The computing device according to claim 9, wherein the processor is further configured to terminate the dynamic connection in response to a termination data packet received by the computing device from the transmitting device that comprises one or more instructions for terminating the dynamic connection.

12. The computing device according to claim 9, wherein the computing device and the transmitting device are formed in a network having a common global time field.

13. The computing device according to claim 12, wherein the threshold time period (T) is received by the computing device from a global time field source associated with the network.

14. The computing device according to claim 12, wherein the threshold time period (T) is determined at least in part based upon an average Round Trip Time (RTT) for the network.

15. The computing device according to claim 9, wherein one or more data entries of the first data packet comprise the threshold time period (T).

16. The computing device according to claim 9, wherein the processor is further configured to:
receive a second data packet comprising one or more data entries indicative of a time at which the second data packet was transmitted by the transmitting device;
store the second data packet in an instance in which the time at which the second data packet was transmitted is in within the threshold time period (T); and
discard the second data packet in an instance in which the time at which the second data packet was transmitted is outside the threshold time period (T).

17. A computer program product comprising at least one non-transitory computer-readable storage medium having computer program code thereon that, in execution with at least one processor, configures the computer program product for:
receiving, by a destination device, a first data packet from a transmitting device, wherein the first data packet comprises one or more instructions for establishing a dynamic connection (DC) between the destination device and the transmitting device;
establishing the dynamic connection between the destination device and the transmitting device based on the first data packet; and
maintaining the dynamic connection between the destination device and the transmitting device for at least a threshold time period (T) defining a duration during which data packets are received by the destination device from the transmitting device, wherein each of the data packets received by the destination device from the transmitting device via the dynamic connection during the threshold time period comprise one or more data entries indicative of a time at which the respective data packet was transmitted by the transmitting device.

18. The computer program product according to claim 17, further configured for terminating the dynamic connection in response to a termination data packet received by the destination device from the transmitting device that comprises one or more instructions for terminating the dynamic connection.

19. The computer program product according to claim 17, wherein the destination device and the transmitting device are formed in a network having a common global time field and the threshold time period (T) is determined at least in part based upon an average Round Trip Time (RTT) for the network.

20. The computer program product according to claim 17, further configured for:
receiving a second data packet comprising one or more data entries indicative of a time at which the second data packet was transmitted by the transmitting device;
storing the second data packet in an instance in which the time at which the second data packet was transmitted is in within the threshold time period (T); and
discarding the second data packet in an instance in which the time at which the second data packet was transmitted is outside the threshold time period (T).
